(19) United States
(12) Patent Application Publication
(10) Pub. No.: US 2008/0026724 A1
(43) Pub. Date: Jan. 31, 2008

(54) Method for wireless local area network user set-up session connection and authentication, authorization and accounting server

(75) Inventor: Wenlin Zhang, Shenzhen (CN)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: HUAWEI TECHNOLOGIES CO., LTD.

(21) Appl. No.: 11/649,841

(22) Filed: Jan. 5, 2007

Related U.S. Application Data
(63) Continuation of application No. PCT/CN05/00987, filed on Jul. 5, 2005.

(30) Foreign Application Priority Data
Jul. 5, 2004 (CN) 200410069176.9

(51) Int. Cl. H04M 1/66

(52) U.S. Cl. 455/411

(57) ABSTRACT

A method for a WLAN user establishing a session connection includes: determining whether an authentication corresponds to a new session connection by a device performing the authentication for a WLAN user; and determining whether an ongoing session connection is to be deleted according to at least one of a network configuration rule, user subscription information and whether a limit of the number of session connections for the WLAN user is exceeded, upon determining that the authentication corresponds to the new session connection. The invention may prevent one WLAN user from performing access authentication in multiple AAA Servers, thereby avoiding dispersion of the user data. Meanwhile, the implementation of the method is simple, convenient and flexible.

### FIELD OF THE TECHNOLOGY

The embodiments of the present invention relate to the technology for establishing connections with a Wireless Local Area Network (WLAN), and more particularly, to a method for a WLAN user establishing session connections with the WLAN and an Authentication, Authorization and Accounting (AAA) server.

### BACKGROUND OF THE INVENTION

Due to the increasing requirement for the wireless-access speed, the WLAN, with the capability of providing a high-speed wireless data access in narrow area emerges. Generally, a WLAN involves various technologies. Nowadays, the technical standard applied widely includes the IEEE 802.11b with transmission in 2.4 GHz radio frequency band which has a data transmission speed up to 1 Mbps. The technical standard IEEE 802.11g and the Bluetooth technology also use the 2.4 GHz band, and the highest transmission speed of the IEEE 802.11g may reach 54 Mbps. Other new technologies, such as the IEEE 802.11a and the ETSI BRAM Hiperlan2, adopt the 5 GHz band and the highest transmission speed may also reach 54 Mbps.

Although the WLAN involves various wireless access technologies, most of them are used to transmit Internet Protocol (IP) packet data. For a wireless IP network, the adopted special WLAN access technology is generally transparent to the upper-level IP. The basic architecture of these technologies is to implement the wireless access of WLAN User Equipment (WLAN UE) through an Access Point (AP) and implement an IP transmission network with controlling and connecting devices.

With the rise and development of the WLAN technology, interworking between a WLAN and other wireless mobile communication networks, such as Global System for Mobile communications (GSM), Code Division Multiple Access (CDMA) system, Wideband Code Division Multiple Access (WCDMA) system, Time Division-Synchronization Code Multiple Access (TD-SCDMA) system and CDMA2000 system, becomes a focus of study at present. In the 3rd Generation Partner Project (3GPP) standardization organization, WLAN UE may communicate with the Internet or the Intranet via a WLAN access network, and may also communicate with the 3GPP home network or with the 3GPP visited network via the WLAN access network. Specifically, when accesses the network locally, the WLAN UE communicates with the 3GPP home network via the WLAN access network, as shown in FIG. 2. When the WLAN UE roams, it communicates with the 3GPP visited network via the WLAN access network, as shown in FIG. 1, in which, some entities in the 3GPP visited network connect with the corresponding entities in the 3GPP home network. For example, an AAA Proxy in the 3GPP visited network is connected with an 3GPP AAA Server in the 3GPP home network; a Wireless Access Gateway (WAG) in the 3GPP visited network is connected with a Packet Data Gateway (PDG) in the 3GPP home network.

As shown in FIGS. 1 and 2, the 3GPP system mainly includes a Home User Server (HSS)/Home Location Register(HLR), a 3GPP AAA Server, a 3GPP AAA Proxy, a WAG, a PDG, an Offline Charging System and an Online Charging System (OCS). A 3GPP-WLAN interworking network may be constituted by WLAN UE, the WLAN access network and all entities of the 3GPP system, and may be used as a WLAN service system. In such a system, the 3GPP AAA Server is in charge of the authentication, authorization and accounting for the users, meanwhile, collects and transmits charging information sent by the WLAN access network to a charging system. The PDG transmits user data from the WLAN access network to the 3GPP network or to other packet networks. The charging system receives and records the user charging information sent from the network and the online charging information periodically sent by the network. The OCS instructs the network to send the online charging information periodically according to accounting information of the online charging user, and performs statistic and control functions.

Under the non-roaming circumstances, when a WLAN user wants to access the Internet/Intranet directly, the WLAN user may utilize WLAN UE to access the Internet/Intranet via the WLAN access network after performing the access authentication and authorization with the AAA Server (AS) via the WLAN access network. If the WLAN UE also wants to access 3GPP packet switch (PS) domain services, it may apply for a WLAN 3GPP IP Access Service from the 3GPP home network. That is, the WLAN UE sends an authentication request for the WLAN 3GPP IP Access Service to the 3GPP home network AS, and the AS performs service authentication and authorization for the authentication request. If the authentication and authorization succeed, the AS sends an Access Accept message to the WLAN UE and the WLAN UE may establish a tunnel with the PDG to access the 3GPP PS domain service. At the same time, the Offline Charging System and the OCS record the charging information according to the network usage situation. Under the roaming circumstances, when the WLAN UE wants to access the Internet/Intranet directly, it may apply to the 3GPP home network for accessing the Internet/Intranet, via the 3GPP visited network. If the WLAN UE also wants to apply for the WLAN 3GPP IP Access Service to access the 3GPP PS domain service, it needs to initiate a service authentication process with the 3GPP home network via the 3GPP visited network. This process is also performed between the WLAN UE and the 3GPP home network AS. When the authentication succeeds, the WLAN UE may establish a tunnel with the PDG via the 3GPP visited network WAG and access the 3GPP PS domain service of the 3GPP home network.

However, according to the 3GPP protocol, in the conventional 3GPP-WLAN interworking networks, the authentication and authorization procedure for the WLAN users accessing the network provides no technical solution for the following situation, that is, if there are more than one AAA server providing services and the WLAN user has been connected with one of them, how to ensure that the WLAN user is connected with the same one AAA Server when the WLAN user initiates another authentication process. In the Home Public Land Mobile Network (HPLMN), multiple AAA Servers may have the ability of providing services for the WLAN users, thus a certain user may access AAA Server 1 for the first authentication and may access AAA Server 2 for a next authentication. Then AAA Server 2 may interact with the HSS and ask for the subscription data. As a result, multiple session connections may be established for one WLAN user, which not only leads to decentralized user data and impossibility of concentrated management, but also takes up a great deal of system resources.

Although a technical solution for preventing one WLAN user from establishing multiple session connections has been put forward, the concrete implementation of the technical solution needs the HSS to perform multi-condition judgments, which makes the process complicated and increases load of the HSS.

### SUMMARY OF THE INVENTION

In view of the above, embodiments of the present invention provide a method for a WLAN user establishing session connections and an AAA Server to present a WLAN user from accessing multiple AAA Servers for authentication and to avoid dispersion of the user data. Meanwhile, the method may be implemented simply, conveniently and flexibly.

In an aspect of the invention, a method for a WLAN user establishing session connections includes the following steps. A device performing an authentication for a WLAN user may determines whether the authentication corresponds to a new session connection. Upon determining that the authentication corresponds to the new session connection, the device determines whether an ongoing session connection is to be deleted according to at least one of a network configuration rule, user subscription information and whether a limit of the number of session connections for the WLAN user is exceeded.

In another aspect of the invention, an AAA Server is adopted for determining whether an authentication corresponds to a new session connection for a WLAN user; and determining whether an ongoing session connection is to be deleted according to at least one of a network configuration rule, user subscription information and whether a limit of the number of session connections for the WLAN user is exceeded, upon determining that the authentication corresponds to the new session connection.

In the course of an authentication, if the AAA Server finds that the session connection corresponding to the current authentication is different from any one of the ongoing session connections, the AAA Server performs normal processes in an allowed limit. However, when the limit is exceeded, the AAA Server needs to decide whether an ongoing session connection should be deleted or the new session connection should be rejected. Then, according to the decision, the subsequent rejection processes or the cancellation processes may be performed. Thus, only one AAA Server is ensured to provide services for the same user so as to avoid dispersion of the user data or waste of system resources, thereby ensuring centralized management of the data.

Whether one WLAN user has established multiple session connections or not may be decided just by determining whether the user information or the network information carried in the current authentication request is the same as that stored in the AAA Server. The implementation of the method is simple and convenient without increasing the load of the HSS or complicating the authentication process.

### BRIEF DESCRIPTION OF THE DRAWINGS

FIG. 1 is a schematic diagram illustrating a structure of the WLAN-3GPP interworking;

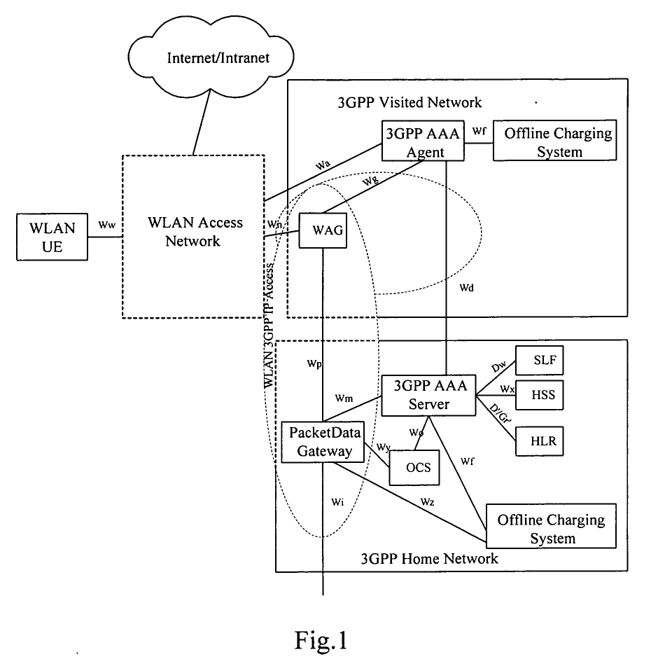

FIG. 2 is a schematic diagram illustrating a networking structure of a WLAN operating network;

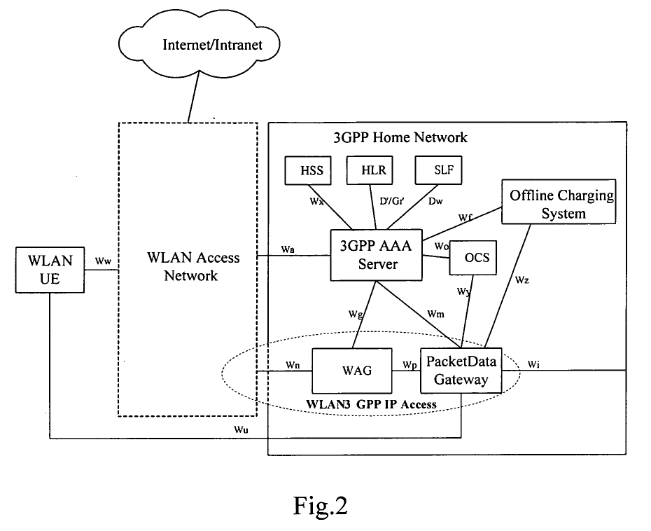

FIG. 3 is a flowchart of an authentication and authorization procedure for WLAN UE;

FIG. 4 is a flowchart of the processing in accordance with a first embodiment of the present invention;

FIG. 5 is a flowchart of the processing in accordance with a second embodiment of the present invention;

FIG. 6 is a flowchart of the processing in accordance with a fifth embodiment of the present invention; and

FIG. 7 is a flowchart of the processing in accordance with a sixth embodiment of the present invention.

### DETAILED DESCRIPTION OF THE INVENTION

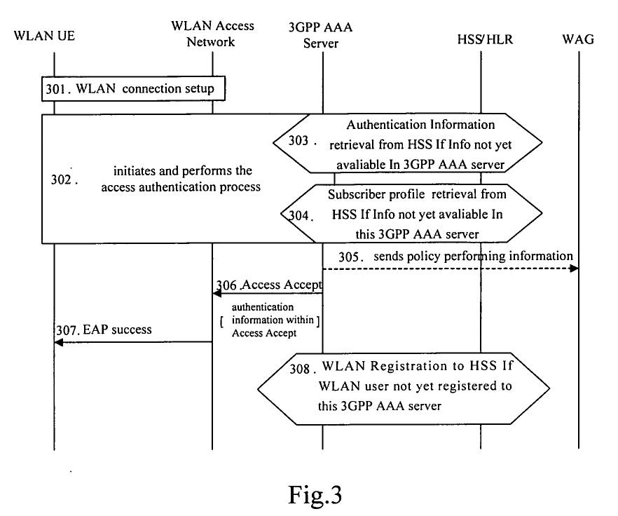

According to the 3GPP protocol, in the conventional 3GPP-WLAN interworking networks, the process of authentication and authorization for a WLAN user accessing the network is shown in FIG. 3.

Steps 301-302: The current WLAN UE establishes a wireless connection with the WLAN access network according to the 3GPP protocols, and initiates a process for the access authentication with the 3GPP AAA Server. The access authentication process may be performed according to the Extensible Authentication Protocol (EAP), i.e., the current WLAN UE may interact EAP request messages and EAP response messages with the 3GPP AAA Server.

Steps 303-304: Upon receiving an access request, the 3GPP AAA Server checks whether authentication information related to the current WLAN UE is available in this 3GPP AAA Server. If the authentication information is not yet available, the 3GPP AAA Server retrieves authentication information, such as an Authentication 5 tuple/3 tuple from the HSS. Furthermore, if subscriber profile is not yet available in the 3GPP AAA Server, such as authorization information and the user temporary identifier of the current WLAN UE, the 3GPP AAA Server also retrieves such information from the HSS. In other words, as long as user information is not yet available in the 3GPP AAA Server, the 3GPP AAA Server retrieves the information from the HSS.

Step 305: The 3GPP AAA Server may send a policy implementation message to the WAG of a Visited Public Land Mobile Network (VPLMN) where the current WLAN UE roams. The step is optional.

Step 306: If the authentication and authorization succeed, the 3GPP AAA Server sends an Access Accept message to the WLAN access network to allow the access. The Access Accept message includes an EAP Success message which carries the authentication information for connection. The authentication information for connection may be an access filtering rule or tunnel attribute, etc.

Step 307: Upon receiving the Access Accept message, the WLAN access network sends to the current WLAN UE the EAP Success message to indicate a success of the authentication.

Step 308: If in the HSS, there is not registration information of the 3GPP AAA Server providing access Authentication for the current WLAN UE, the 3GPP AAA Server providing the authentication for the current WLAN UE is registered in the HSS. In the registration message, the WLAN user may be determined by the user temporary identifier.

According to an embodiment of the present invention, in an interactive access authentication process for a WLAN, an AAA Server determines whether the authentication corresponds to a new session. If the authentication corresponds to a new session, the AAA Server determines whether the limit of the session connections defined by the network for the WLAN user is exceeded after adding the new session connection. When the limit is exceeded, the AAA Server may delete one of the ongoing sessions or reject the setup of the new session. If the AAA Server determines to reject the new session, the rejecting operation may be performed before the authentication or in course of the authentication. Otherwise, if the AAA Server determines to delete an ongoing session connection, the deleting operation may be performed after the new session authentication succeeds. Thus, each WLAN user is ensured to get an access service for authentication from only one AAA Server. In other embodiments, the AAA Server may be replaced by any device enabling g an authentication for the WLAN user.

The AAA Server determines whether the authentication corresponds to a new session by the way of determining whether the current session connection is different from any one of the ongoing session connections according to Medium Access Control (MAC) address of the WLAN UE, identifier information of the WLAN access network, or identifier information of the VPLMN. Such information is carried to the AAA Server in course of the authentication. In course of the authentication, any difference of the above information between the current session connection and one of the ongoing session connections means that the two sessions are different. The information may be carried in the authentication signaling initiated by the WLAN UE, or may be carried in an AAA signaling provided by the Network Access Server (NAS) to send to the AAA Server, or may be provided to the AAA Server by means of one or more interactions between the AAA Server and the WLAN UE. An interaction process for determining whether a session connection should be deleted or the setup request of the new session should be rejected may be started as needed, and the session connection to be deleted is selected from the ongoing session connections.

The AAA Server determines whether the limit of the session connections defined by the network for the WLAN user is exceeded, according to some deciding rules. The deciding rules containing either of the network configuration and the user subscription information may be categorized into the following conditions:

A. It is not allowed for a WLAN user to establish multiple connections according to the network or the subscription information of the user. That is, only one connection is allowed for a WLAN user. In this case, there are three kinds of deciding rules: \textcircled{1} The session connection to be deleted is an ongoing session connection. \textcircled{2} The network determines whether the ongoing session connection is active. When the ongoing session connection is active, the network rejects the request of the new session connection, and indicates the WLAN user that the failure causes is that the new connection is beyond the limit. \textcircled{3} The network determines whether the ongoing session connection is active. When the ongoing session connection is active, the network compares the access priority of the currently requested new session connection and the access priority of the ongoing session connection according to the identifier information of the session connection, and if the ongoing session connection has higher priority, the request of the new session connection may be rejected; if the ongoing session connection has lower priority, it may be deleted.

B. Establishing multiple connections for a WLAN user is allowed. In this case, there are several kinds of deciding rules as follows: \textcircled{1} The ongoing session connection may be confirmed as an active connection so as to confirm that the current session of the connection exists. When the session connection to be deleted is one of the ongoing session connections, a session connection without response or with the longest waiting time for response is deleted preferably. During the determining process, An active connection refers to a connection having a session in the active state. The confirmation mentioned above refers to initiate a confirmation process for a session that has no dynamic interaction with others for a certain period of time. For example, a re-authentication process, such as a rapid re-authentication process or a simple interactive signaling process may be performed to confirm the presence of the session. \textcircled{2} When initiates a new authentication for a session, the WLAN UE directly carries the session identifier of an ongoing session to be deleted, then the network deletes the ongoing session according to the session identifier. The session connection to be deleted may be marked directly, or be decided by the AAA Server by detecting the active state or comparing the priorities of the ongoing sessions. \textcircled{3} The network initiates signaling interaction with the WLAN UE and requires the user to decide which session connection may be deleted. In course of the interaction, setting a password or other authentication measures for selection authority for deleting other session connections may be required. \textcircled{4} When the new connection is the connections beyond the limit, the network determines whether an ongoing session connection is inactive. The ongoing session connections that are inactive may be deleted and the new session connection may access the network. If all the ongoing session connections are active, the network rejects the new session connection and prompts the WLAN UE that the failure cause of the new connection is the connections beyond the limit. \textcircled{5} The network performs an authentication for the new session connection, and when the authentication succeeds, deletes the ongoing session connection with the lowest priority. \textcircled{6} The network determines whether an ongoing session connection is active. These ongoing session connections that are inactive may be deleted and the new session connection may access the network. If all the ongoing session connections are active, the network may decide which session may be deleted according to the properties in the identifier information of the user session. For example, when the priority of the VPLMN2 of the new session is lower than that of the VPLMN1 of the ongoing session, the network rejects the new session setup request, otherwise, deletes the ongoing session connection with the lowest priority after the new session authentication succeeds.

C. The WLAN user subscribes to select a customized policy for deleting a session connection when the new session connection is beyond the limit. For instance, if all the ongoing session connections are active, the network may reject the new session connection, or select and delete an ongoing session connection according to the active state, connecting time of the session and so on, or select an ongoing session connection according to the priorities of the session connections. The priority of a session connection may be determined according to the configured parameters.

The technical solution mentioned above is mainly applicable to the following case: The network is capable of ensuring that only one AAA Server provides the access authentication service for a WLAN user, and then the AAA Server performs the determining process of the authentication for multiple session connections.

### Embodiment 1

This embodiment describes judgment logic in a device with enhanced functions, i.e., a judgment for determining whether multiple session connections belonging to one WLAN user exist in the network is added to the device in order to ensure that only one device provides the service for the current WLAN user. In this embodiment, first decide whether the new session connection should be deleted, and then decide whether an authentication should be performed for the new session connection.

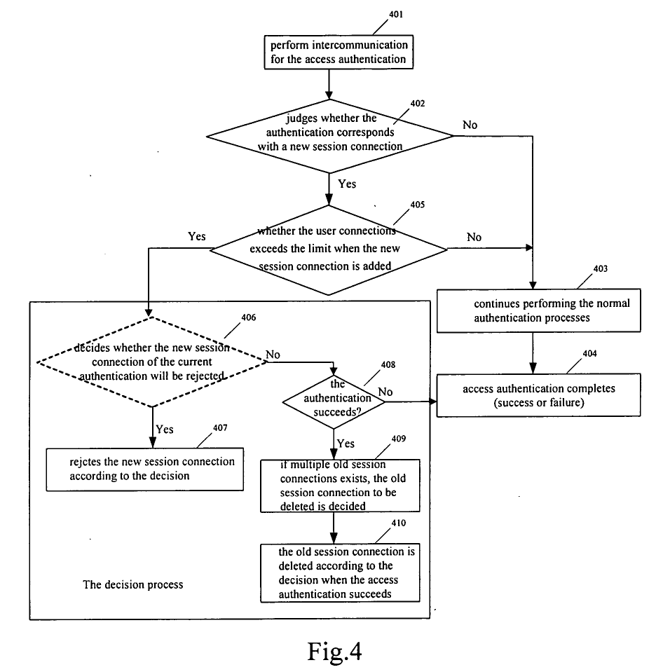

As shown in FIG. 4, the judgment procedure of the device in this embodiment includes the following steps:

Steps 401-404: In an interactive access authentication process, a device which performs an authentication for WLAN UE initiates an authentication request, and determines whether the currently requested authentication corresponds to a new session connection. If the currently requested authentication doesn't correspond to a new session connection, a normal authentication process may be continued and the current judgment procedure should be terminated. And a successful or failure response is retuned to the WLAN UE initiating the authentication request after the access authentication is completed. If the currently requested authentication corresponds to a new session connection, perform step 405.

Step 405: The device determines, in case that the new session connection passes the authentication, whether this session connection of the WLAN UE initiating the authentication request is beyond the session limit set by the network according to at least one of the network configuration rules and the user subscription information. If the limit is not exceeded, the current procedure is terminated and the normal authentication process is performed, i.e., steps 403˜404 are performed. If the limit is exceeded, an interactive determining process is started, i.e., steps 406˜410 are performed.

Steps 406˜410: Decide whether to reject the new session connection corresponding to the currently requested authenticated. If the new session connection is determined to be deleted, reject the new session setup request according to the decision and terminate the current process, otherwise, the device determines whether the authentication succeeds. If the authentication fails, the device returns to the WLAN UE an access authentication failure response and terminates the process. If the authentication succeeds, the device determines to delete the ongoing session connection. If there are multiple ongoing session connections, the device determines which one of the ongoing session connections may be deleted. After the new session connection authentication is successful, the selected ongoing session connection is deleted. The specific process and rules mentioned in step 406 and step 409 are described as follows:

First, initiate for the ongoing connections a re-authentication process, such as a rapid re-authentication process or a simple test signaling that requires for a response from the WLAN UE. If the authentication succeeds or a response is returned to respond the test signaling, it means that the ongoing session connection is active, otherwise, the ongoing session connection is inactive and remaining information of the ongoing session connection may be deleted via a deleting process.

If one or more ongoing session connections have been deleted already, the authentication for the new session connection may be going on. If all the ongoing session connections are in active state, the priority of the new session connection and those of the ongoing session connections may to be determined according to priority reference data that are set in accordance with the session identity parameters, and the session connection with the lowest priority may be selected. If the selected session connection is the session connection authenticated currently, the authentication of the selected session connection is rejected, namely, the new session setup request is rejected. If the selected session connection is an ongoing session connection, a process for deleting the selected ongoing session connection is initiated after the new session connection authentication succeeds. The session identity parameters may be a VPLMN identifier, the identifier information of the WLAN access network, and a MAC address of the WLAN UE.

In this embodiment, the device may be an AAA Server.

### Embodiment 2

This embodiment describes another judgment logic diagram in an AAA Server with enhanced functions, i.e. a judgment for determining whether multiple session connections belonging to one WLAN user exist in the network is added to the AAA Server in order to ensure that only one AAA Server provides the service for the current WLAN user. In this embodiment, it is decided to delete a certain ongoing session connection, so the authentication for the new session connection may be performed directly. It should be noted that the AAA Server also may be any device performing an authentication for a WLAN UE.

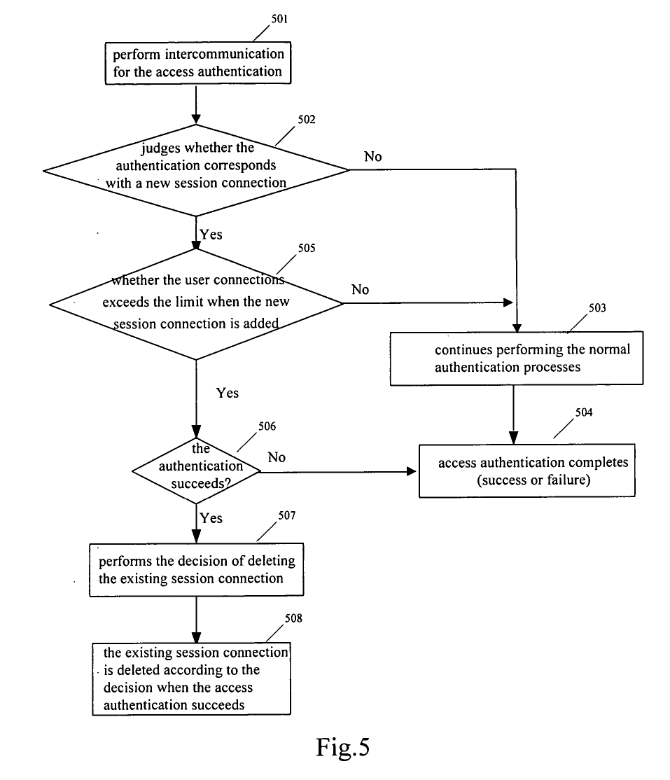

As shown in FIG. 5, the judgment procedure of the AAA Server in this embodiment includes the following steps.

Steps 501˜504 are the same as what is described in steps 401˜404 of Embodiment 1.

Steps 505˜508: The AAA Server determines, in case that the new session connection passes the authentication, whether the session connection of the WLAN user is beyond the session limit set by the network. If the limit is not exceeded, the normal authentication process may be performed, i.e., steps 503˜504 are performed. If the limit is exceeded, the current session connection is deleted and the new session connection accesses the network if the current session connection is the only one of ongoing connection in the network, otherwise, an interactive determining process may be started to decide the priorities of the ongoing session connections. That is, the priority of the new session connection and those of all the ongoing session connections may be decided according to the priority reference data set in accordance with the session identity parameters. The session connection with the lowest priority may be selected and deleted. The session identity parameters are the VPLMN identifier, the identifier information of the WLAN access network, the MAC address of the WLAN UE, etc.

### Embodiment 3

This embodiment is based on the processing flow of FIG. 3 and combines the interactive process with the processing steps of the core idea of the present invention. The main changes occur in step 302, step 303 and step 304 while other steps remain unchanged. In this embodiment, the main changes in step 302 are described hereinafter.

In course of the interactive process for authentication, a judgment function for determining whether the current authentication corresponds to a new session connection is added in the AAA Server. If the current authentication corresponds to a new session connection, the AAA Server determines whether the limit of the session connection defined by the network for the WLAN user may be exceeded after adding the new session connection. When the limit is exceeded, the AAA Server may delete a connection of a certain ongoing session or reject the setup of a new session. If the AAA Server determines to reject the new session, the rejecting operation may be performed before the authentication or in course of the authentication. If the AAA Server determines to delete an ongoing session connection, the deleting operation is performed after the new session authentication succeeds. The step 302 is actually a determining process and the specific interactive determining processes are the same as what described in steps 406˜410 of Embodiment 1.

The main changes in step 303 and step 304 are that ensure that only one AAA Server provides the service for one WLAN user by interaction between the AAA Server and the HSS. That is, prevent one WLAN user from simultaneous communicating with multiple AAA Servers, and avoid one WLAN user accessing multiple AAA Servers for authentication.

Specifically, in step 303, a judgment on the AAA Server currently requiring the user information is added in the HSS. After receiving the request for user subscription information from the AAA Server, the HSS checks whether there is the AAA registration of the AAA Server communicating with the WLAN UE in the HSS. If the HSS can't find the AAA registration, the normal process is continued. If the AAA registration is obtained, the HSS determines whether the registered AAA Server and the AAA Server sending the request are the same. If the two are the same, the normal process is continued. If the two are not the same but the HSS determines to use the one that currently sends the request, the normal process is continued while a step of deleting the information and the connection of the registered AAA Server which relates with the current WLAN user is added in step 308 or after step 308.

If the two AAA Server are not the same and the HSS determines to use the registered AAA Server, the HSS returns the address of the registered AAA Server to the one that sends the request currently. The AAA Server sending the request currently transmits the access authentication request to the registered AAA Server, and the registered AAA Server performs step 303 and the follow-on steps.

### Embodiment 4

This embodiment is based on the processing flow of FIG. 3 and combines the interactive process with the processing steps of the core idea of the present invention. The main changes occur in step 302, which are the same as those of Embodiment 3, while other steps remain unchanged.

The differences between this embodiment and Embodiment 3 are described as follows. It is not necessary to modify step 303 and step 304. However, the pre-configuration of the network and plan of the routes for authentication are carried out. The user information and user data are routed to a special AAA Server according to different characteristics of the user identity to ensure that one WLAN user can not access multiple AAA Servers. Alternatively, in a special case of application, only one AAA Server provides the service for the WLAN users in the whole network and the AAA server may be a combination of multiple AAA Server entities. The multiple AAA Server entities are the backup of each other to provide disaster tolerance and load sharing while appearing as one AAA Server to the outside. The user identity mentioned here may be a Network Access ID (NAI) of the WLAN user, a temporary user name or a permanent name.

### Embodiment 5

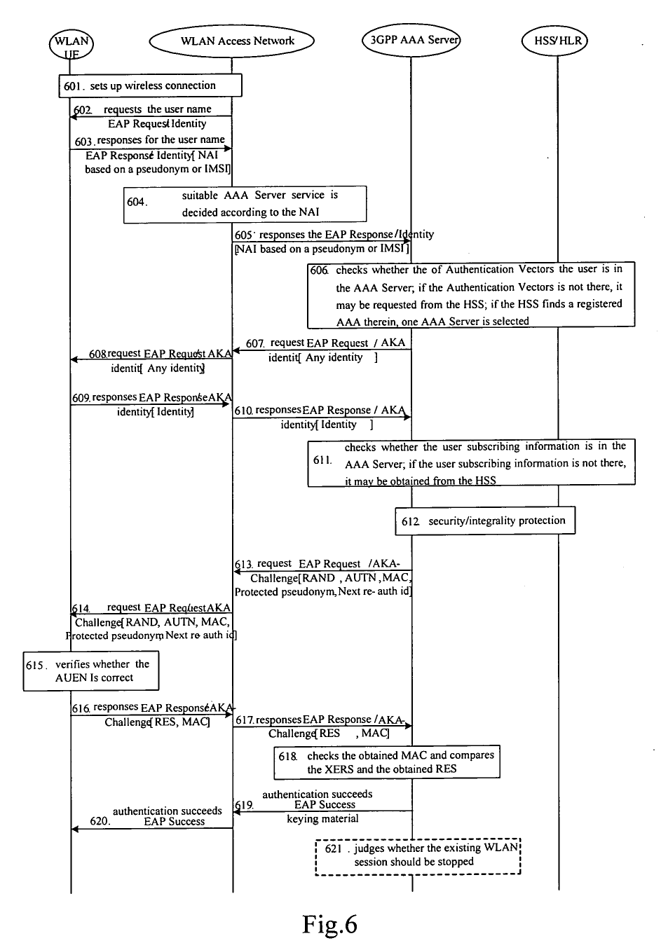

This embodiment is an application of the present invention in the WLAN access authentication process with the EAP-AKA mechanism. The basic process of the EAP-AKA authentication is defined in detail by the specifications. This embodiment mainly describes how to ensure only one AAA Server providing the service for one WLAN user when the process is performed on a WLAN-3GPP interworking network. As shown in FIG. 6, the method of this embodiment includes the following steps:

Step 601: The WLAN UE and the WLAN access network establish a wireless connection according to the WLAN specifications.

Step 602: The WLAN access network sends a user name request signaling, i.e. an EAP Request/Identity, to the WLAN UE, wherein the encapsulated protocol of the EAP contents depends on the specific protocol adopted by the WLAN.

Step 603: The WLAN UE returns a user name response message, i.e., an EAP Response/Identity which includes an identifier of the WLAN UE. The identifier of the WLAN UE adopts the NAI defined by the RFC 2486 in the EETF specification. The NAI may be a temporary identifier allocated in the latest authentication or a permanent identifier, e.g., an International Mobile Subscriber Identity (IMSI). The method for the IMSI constructing the NAI format is defined in detail in the EAP/AKA specification and is not described here any more.

Step 604: According to the NAI domain name, the authentication message initiated by the WLAN UE is routed to a suitable 3GPP AAA Server. There may be one or more AAA agents (not shown) in the route. The route to the AAA Server may be found and decided by the Diameter referral method, or may be decided by the configured data.

Step 605: The 3GPP AAA server receives the EAP Response/Identity message that includes the user identity, the identifier of the WLAN access network, the VPLMN identifier and the MAC address of the WLAN UE.

Step 606: The 3GPP AAA Server regards the WLAN user as a candidate of the EAP-AKA authentication according to the received identifiers, and then checks whether Authentication Vectors that the WLAN user hasn't used exists in the AAA server itself. If there aren't Authentication Vectors that the WLAN user hasn't used, the 3GPP AAA Server requests for the Authentication Vectors from the HSS/HLR. Meanwhile, a comparison list of the temporary identifiers and the IMSI is needed. The 3GPP AAA Sever may first obtain Authentication Vectors that have not been used, e.g., UMTS Authentication Vectors, and then decide whether to take this WLAN user as a candidate of the EAP-AKA authentication based on the obtained Authentication Vectors.

After receiving the request, if the HSS/HLR finds that there is another 3GPP AAA Server having been registered as the serving AAA of the WLAN user and the registered AAA Server works well, the HSS/HLR sends the address of the registered AAA Server to the 3GPP AAA Server which requiring for the Authentication Vectors. And then, the 3GPP AAA Server that requires for the Authentication Vectors acts as a PROXY agent or a REDIRECTION agent to transmit the Authentication message to the registered 3GPP AAA.

Step 607: Because the user identities contained in the EAP Response/Identity message may be changed or replaced by the intermediate nodes, the 3GPP AAA Server sends an EAP Request/AKA Identity message to request the user identity again. However, if it is sure that the user identity contained in the EAP Response/Identity message is impossible to be changed, the corresponding processing steps may be omitted by the home network operator.

Steps 608-609: The WLAN access network forwards the EAP Request/AKA Identity message to the WLAN UE and the WLAN UE responds with a user identity which being the same as the one in the EAP Response/Identity message.

Step 610: The WLAN access network forwards the EAP Response/AKA Identity message to the 3GPP AAA Server and the 3GPP AAA Server uses the user identity contained in the received message to perform the authentication. If the user identity in the EAP Response/Identity differs from the one in the EAP Response/AKA Identity, the user subscription information and the Authentication Vectors obtained from the HSS/HLR are all invalid and a request has to be sent again. That is, it is needed to repeat the process of requesting the Authentication Vectors in step 606 before going to the step 611.

To optimize the process, if the 3GPP AAA Server has enough information to identify a WLAN USE as an EAP-AKA user, the process of re-requesting the identifier again may be performed before obtaining the user subscription information and the Authentication information, although the Wx interface protocol may not allow the above four steps to be performed before the user subscription information has been downloaded to the 3GPP AAA Server.

Step 611: The 3GPP AAA Server checks whether the user subscription information required for accessing the WLAN exists. If this information is not in the 3GPP AAA Server, it may be obtained from the HSS, and then the 3GPP AAA Server checks whether the WLAN user has been authorized to use the WLAN access service.

Although in this embodiment, step 611 is performed after the step 606, this step may be performed in any place before step 614 in actual applications.

Step 612: Deduct new key information from an integrity key IK and a cipher Key CK and the specific process for deducting the new key information are defined in the specifications. This new key information is required by the EAP-AKA. It is obvious that more key information may be produced and provided for the confidentiality and integrity protection of the WLAN access.

A new alias may be selected and protected by the key information produced by the EAP-AKA.

Step 613: The 3GPP AAA Server sends the information contained in the EAP Request/AKA-Challenge message to the WLAN access network. The information may be a random number RAND, an authentication token AUTN, a Message Authentication Code (MAC) and two user identities (if there are), wherein the two identifiers refer to the aliases which are protected and/or a re-Authentication ID. Whether the Re-Authentication ID is sent depends on whether the operating rules of the 3GPP operator permit the re-Authentication mechanism. That is, the AAA server determines whether the Re-Authentication ID is contained in the EAP Request/AKA-Challenge message according to the rules of the operator to decide whether a re-Authentication process is allowed.

Step 614: The WLAN access network sends the EAP Request/AKA-Challenge message to the WLAN UE.

Step 615: The WLAN UE performs the UMTS algorithm in a USIM and the USIM verifies the AUTN to authenticate the network. If the AUTN is incorrect, the WLAN UE rejects the authentication process. If the sequence number is not synchronized, the WLAN UE initiates a synchronizing process. Detailed description is defined in the specifications and no more description hereinafter. If the AUTN is correct, the USIM calculates a RES, the integrity key IK and the cipher Key CK.

The WLAN UE calculates other new key information according to the integrity key IK and the cipher Key CK that is calculated by the USIM and uses the key information to check the obtained Message Authentication Code.

If receives a protected alias, the WLAN UE stores the alias for future use of authentication.

Step 616: The WLAN UE uses the new key information to calculate a new Message Authentication Code value which covering the EAP message and sends the EAP Response/AKA-Challenge message that includes the calculated RES and the new calculated Message Authentication Code value to the WLAN access network.

Step 617: The WLAN access network forwards the EAP Response/AKA-Challenge message to the 3GPP AAA Server.

Step 618: The 3GPP AAA Server checks the obtained Message Authentication Code and compares the XRES and the obtained RES.

Step 619: If all checks are passed, the 3GPP AAA Server sends an Authentication success message, i.e. an EAP Success message, to the WLAN access network. If some new keys prepared for security or integrality protection of the WLAN access are generated, the 3GPP AAA Server makes the key information included in a message of the AAA layer protocol which bearing the EAP message. That is, the key information is not included in the signaling of the EAP layer. The WLAN access network stores these keys for communicating with the WLAN UE which passes the authentication.

Step 620: The WLAN access network uses the EAP Success message to inform the WLAN UE that the WLAN UE has passed the authentication. By now, the interaction of the EAP AKA is completed successfully and both the WLAN UE and the WLAN access network have the shared key information generated during the interaction.

Step 621: The 3GPP AAA Server compares the MAC address of the WLAN UE, the VPLMN identifier and the identifier information of the WLAN access network in course of the authentication interaction with the corresponding information of the WLAN user who corresponds to the ongoing session. If the information is consistent with the information in the ongoing session, the authentication process is a process associated with the ongoing WLAN session and no processing is needed for this session.

If the MAC address of the WLAN UE, or the VPLMN identifier, or the identifier information of the WLAN access network differs from that of the current WLAN session, the 3GPP AAA Server regards that the authentication process is for establishing a new WLAN session. The 3GPP AAA Server then determines whether to initiate a process to terminate the ongoing WLAN session according to whether multiple WLAN sessions of the WLAN user are allowed or whether the maximum number of the WLAN sessions has exceeded the limit.

This step is actually a judging and determining process and the specific interactive determining process is the same as what is described in steps 406˜410 of embodiment 1. The deciding rules may be adopted to select the corresponding process, i.e., rejecting a new session connection request or deleting a certain ongoing session connection, according to whether the network allows the WLAN user to establish multiple connections.

In the above process, the authentication may fail in any stage. For example, when the Message Authentication Code verification fails or there is no response from the WLAN UE after the network sends a request message, the authentication fails. In this case, the EAP AKA process may be stopped and a failure notice message may be sent to the HSS/HLR.

### Embodiment 6

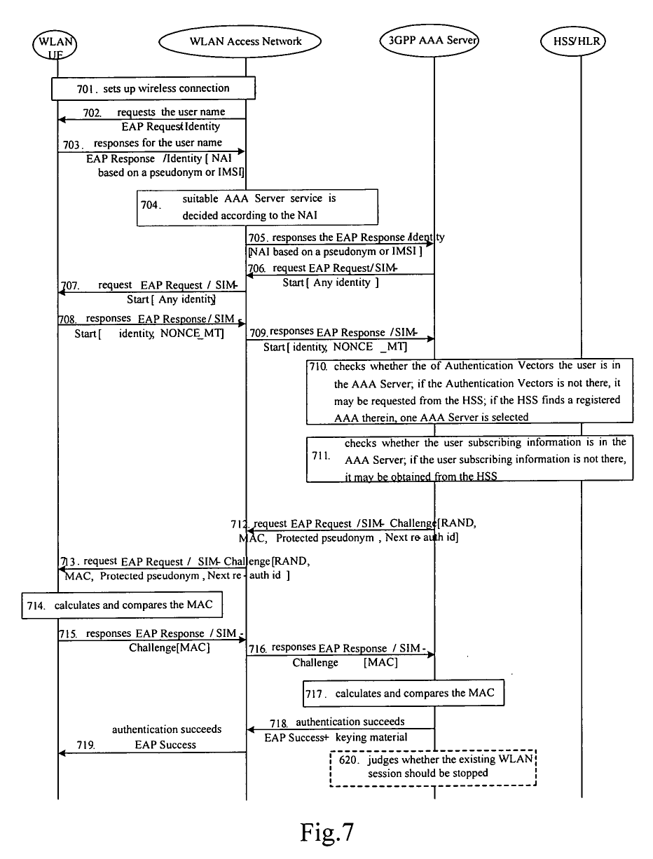

This embodiment is an application of the present invention in the WLAN access authentication process with the EAP-SIM scheme. The basic process of the EAP-SIM authentication is defined in the specifications. This embodiment mainly describes how to ensure one AAA Server providing the service for one WLAN user when the process is performed on the WLAN-3GPP interworking network. As shown in FIG. 7, the method of this embodiment includes the following steps:

Step 701: The WLAN UE and the WLAN access network establish a wireless connection according to the WLAN specifications.

Step 702: The WLAN access network sends a user name request signaling, i.e. the EAP Request/Identity, to the WLAN UE, wherein the encapsulation protocol of the EAP contents depends on the specific protocol adopted by the WLAN.

Step 703: The WLAN UE returns a user name response message, i.e., the EAP Response/Identity, which includes an identifier of the WLAN UE itself. The identifier adopts the NAI defined by the RFC 2486 in the IETF specifications. The NAI may be a temporary identifier allocated in the latest authentication or a permanent identifier, e.g., the IMSI, wherein the method for constructing the NAI format with the IMSI is defined in the EAP/SIM specifications and is not described here any more.

Step 704: According to the NAI domain name, the authentication message initiated by the WLAN UE is routed to a suitable 3GPP AAA Server. Here, there may be one or more AAA agents (not shown) in the route. The route of the AAA Server may be found and decided by the Diameter referral method, or may be decided by the configured data.

Step 705: The 3GPP AAA server receives the EAP/Response/Identity message that includes the user identity, the identifier of the WLAN access network, the VPLMN identifier and the MAC address of the WLAN UE.

Step 706: The 3GPP AAA Server regards the WLAN user as a candidate of the EAP/SIM authentication according to the received identifiers, and sends an EAP Request/SIM-Start to the WLAN access network. Because the user identity contained in the EAP Response/Identity message may be changed or replaced by the intermediate nodes, the 3GPP AAA Server requests the user identity again. However, if it is sure that the user identity contained in the EAP Response/Identity message is impossible to be changed, the corresponding processing steps may be omitted by the home network operator. The 3GPP AAA Sever may first obtain the Authentication Vectors that has not been used, and then decide whether the WLAN user may be regarded as a candidate of the EAP-SIM authentication based on the obtained Authentication Vectors, such as the obtained GSM Authentication Vectors.

Steps 707˜708: The WLAN access network sends the EAP Request/SIM-Start message to the WLAN UE and the WLAN UE selects a new random number NONCE_MT that is used for network authentication. The WLAN UE responds with a user identity which is the same as the one in the EAP Response/Identity.

The EAP Response/SIM-Start sent from the WLAN UE to the WLAN access network includes the NONCE_MT and the user identity.

Step 709: The WLAN access network sends the EAP Request/SIM-Start message to the 3GPP AAA Server and the 3GPP AAA Server uses the user identity contained in the received message to perform the authentication. If the user identity in the EAP Response/Identity differs from the one in the EAP Request/SIM-Start, the user subscription information and the Authentication Vectors obtained from the HSS/HLR are all invalid and it is needed to make a request again.

Step 710: The 3GPP AAA Server checks whether there are N Authentication Vectors that the WLAN user hasn't used in the server itself. If there are, the N Authentication Vectors are used to generate the key information with the same length as that of the EAP/SIM. If there aren't, the 3GPP AAA Server requests for the Authentication Vectors from the HSS/HLR. Meanwhile, a comparison list of the temporary identifiers and the IMSI is also needed.

After receiving the request, if the HSS/HLR finds that there is another 3GPP AAA Server having been registered as the serving AAA of the WLAN user and the registered AAA Server works well, the HSS/HLR sends the address of the registered AAA Server to the 3GPP AAA Server which requesting for the Authentication Vectors. And then, the 3GPP AAA Server which requesting for the Authentication Vectors acts as a PROXY agent or a REDIRECTION agent to transmit the Authentication messages to the registered the 3GPP AAA.

Although in this embodiment, this step is performed after step 709, the step may be performed in any place before step 712 in actual applications, e.g. after step 705.

Step 711: The 3GPP AAA Server checks whether the user subscription information that is required by the WLAN access exists in itself. If this information is not in the 3GPP AAA Server, it may be obtained from the HSS, and then the 3GPP AAA Server checks whether the WLAN user has been authorized to use the WLAN access service. Although in this embodiment, this step is performed after step 710, the step may be performed in any place before step 718 in actual applications.

Step 712: Deduct new key information from the NONCE_MT and N number of Kcs and the specific process for deducting the new key information is defined in the specifications. The new key information is required by the EAP-SIM. It is obvious that more key information may be produced and provided for the security or integrality protection of the WLAN access.

A new alias and/or a re-authentication identifier may be selected and protected by the key information produced by the EAP-SIM. For example, the new alias and/or the re-authentication identifier may be encrypted and integrally protected by using the key information produced by the EAP-SIM.

By a way of using the key to cover the entire EAP message, a Message Authentication Code may be calculated, wherein the key is obtained by adopting the EAP-SIM. The Message Authentication Code may be used to perform the network authentication.

The 3GPP AAA Server sends the information contained in the EAP Request/SIM-Challenge message to the WLAN access network. The information may be a RAND, an AUEN, a Message Authentication Code and two user identities (if there are), wherein the two identifiers refer to the alias which are protected and/or a re-authentication ID. Whether the Re-Authentication ID is sent depends on whether the operating rules of the 3GPP operator contain the re-Authentication mechanism. That is, the AAA server determines whether the re-authentication ID is contained in the EAP Request/AKA-Challenge message according to the rules of the operator to decide whether the re-authentication process is allowed.

Step 713: The WLAN sends the EAP Request/SIM-Challenge message to the WLAN UE.

Step 714: The WLAN UE executes the GSM A3/A8 algorithm for N times in the SIM, one execution for each received RAND. The results of these calculations are N number of SRESs and Kc values.

The WLAN UE calculates other key information according to the N keys of Kc and the NONCE_MT.

The WLAN UE uses the new key information to calculate a Message Authentication Code used for network authentication and determines whether the Message Authentication Code is the same as the Message Authentication Code received. If the MAC calculated is incorrect, the network authentication fails and the WLAN UE cancels the process of authentication. The WLAN UE continues to perform the interaction process of authentication only when the MAC calculated is correct.

The WLAN UE uses the new key information to cover each EAP message associated with the N number of SRESs and calculates a new Message Authentication Code.

When receives a protected alias, the WLAN UE stores the alias for use in future authentication.

Step 715: The WLAN UE sends the EAP Response/SIM-Challenge message that includes the calculated Message Authentication Code to the WLAN access network.

Step 716: The WLAN access network sends the EAP Response/SIM-Challenge message to the 3GPP AAA Server.

Step 717: The 3GPP AAA Server determines whether the obtained Message Authentication Code is the same as the one stored therein.

Step 718: If all checks are passed, the 3GPP AAA Server sends the Authentication success message, i.e. the EAP Success message, to the WLAN access network. If some new keys prepared for security or integrality protection of the WLAN access are generated, the 3GPP AAA Server makes the key information included in a message of the AAA layer protocol which bearing the EAP message. That is, the key information is not included in the signaling of the EAP layer. The WLAN access network stores these keys for communicating with the WLAN UE which passes the authentication.

Step 719: The WLAN access network uses the EAP Success message to inform the WLAN UE that the WLAN UE has passed the authentication. By now, the interaction of the EAP SIM is completed successfully and both the WLAN UE and the WLAN access network have the shared key information generated during the interaction.

Step 720: The 3GPP AAA Server compares the MAC address of the WLAN UE, the VPLMN identifier and the identifier information of the WLAN access network in the authentication interaction with the corresponding information of the WLAN user who corresponds to the ongoing session. If the information is consistent with the information in the ongoing session, the authentication process is the process related to the ongoing WLAN session and no processing of the session is needed.

If the MAC address of the WLAN UE, or the VPLMN identifier, or the identifier information of the WLAN access network differs from those of the current WLAN session, the 3GPP AAA Server may decide that the authentication process is for establishing a new WLAN session. The 3GPP AAA Server then determines whether a process should be initiated to terminate the ongoing WLAN session according to whether multiple WLAN sessions of the WLAN user are allowed or whether the maximum number of the WLAN sessions has exceeded the limit.

The step is actually a determining and determining process and the specific interaction determining process is the same as what is described in steps 406˜410 of embodiment 1. The deciding rules may be adopted to select the corresponding process, e.g., rejecting a new session connection request or deleting a certain ongoing session connection, according to whether the network allows the WLAN user to establish multiple connections.

In the above process, the authentication may fail in any stage. For example, when the Message Authentication Code authentication fails or there is no response from the WLAN UE after the network has sent a request message, the authentication fails. In this case, the EAP SIM process may be stopped and a failure notice message may be sent to the HSS/HLR.

It should be noted that the AAA Server in above preferred embodiments also may be any device performing an authentication for a WLAN UE.

Though the present invention has been illustrated and described by some preferred embodiments, those skilled in the art should understand that various changes may be made in form and detail without departing from the spirit and the scope of the present invention and therefore should be covered in the protection scope of the present invention defined by the appended claims and its equivalents.

What is claimed is:

1. A method for a Wireless Local Area Network (WLAN) user establishing a session connection, comprising:
determining whether an authentication corresponds to a new session connection by a device performing the authentication for a WLAN user; and
determining whether an ongoing session connection is to be deleted according to at least one of a network configuration rule, user subscription information and whether a limit of the number of session connections for the WLAN user is exceeded, upon determining that the authentication corresponds to the new session connection.

2. The method of claim 1, wherein determining whether the authentication corresponds to the new session connection comprises:
determining whether any one of a Mediate Access Control (MAC) address of WLAN User Equipment (WLAN UE) utilized by the WLAN user, identifier information of a WLAN access network and identifier information of a Visited Public Land Mobile Network (VPLMN) which is carried to the device in course of the authentication differs from that of the ongoing session connection.

3. The method of claim 1, wherein determining whether the ongoing session connection is to be deleted comprises:
deleting the ongoing session connection if only one session connection is allowed to be established for the WLAN user.

4. The method of claim 1, wherein determining whether the ongoing session connection is to be deleted comprises:
if only one session connection is allowed to be established for the WLAN user, determining whether the ongoing session connection is active; if the ongoing session is active, rejecting the new session connection corresponding to the authentication; if the ongoing session is not active, allowing the access of the new session connection.

5. The method of claim 4, further comprising:
returning to a WLAN UE utilized by the WLAN user a failure cause that the new session connection is beyond the limit while rejecting the new session connection corresponding to the authentication.

6. The method of claim 4, wherein determining whether the ongoing session connection is active comprises one of:
initiating a re-authentication process to the ongoing session connection; and
sending a test signaling which requires a response from a WLAN UE utilized by the WLAN user.

7. The method of claim 1, wherein determining whether the ongoing session connection is to be deleted comprises:
if only one session connection is allowed to be established for the WLAN user, determining whether the ongoing session connection is active, if the ongoing session is not active, allowing the access of the new session connection; if the ongoing session is active, comparing a priority of the ongoing session connection and that of the new session connection according to identifier information of the session connections, and determining whether the priority of the ongoing session connection is lower than that of the new session connection; if the priority of the ongoing session connection is lower, deleting the ongoing session connection, otherwise, rejecting the new session connection corresponding to the authentication.

8. The method of claim 7, wherein determining whether the ongoing session connection is active further comprises one of:
initiating a re-authentication process to the ongoing session connection; and
sending a test signaling which requires a response from a WLAN UE utilized by the WLAN user.

9. The method of claim 1, wherein determining whether the ongoing session connection is to be deleted comprises:
deleting the ongoing session connection which currently gives no response or has not responded for the longest time if at least two session connections are allowed to be established for the WLAN user.

10. The method of claim 9, further comprising one of:
initiating a re-authentication process to the ongoing session connection; and
sending a test signaling which requires a response from a WLAN UE utilized by the WLAN user to determine whether there is a response from the ongoing session connection.

11. The method of claim 1, wherein determining whether the ongoing session connection is to be deleted comprises:
deleting the ongoing session connection according to a session deletion identifier carried in a session setup request corresponding to the authentication if at least two session connections are allowed to be established and the session deletion identifier is carried in the session setup request.

12. The method of claim 11, wherein the ongoing session connection to be deleted is indicated by the session deletion identifier, and the ongoing session connection indicated by the session deletion identifier is deleted.

13. The method of claim 11, further comprising one of:
initiating a re-authentication process to the ongoing session connection; and
sending a test signaling which requires a response from a WLAN UE utilized by the WLAN user to determine whether there is a response from the ongoing session connection, and deleting the session connection which currently gives no response or has not responded for the longest time.

14. The method of claim 1, wherein when at least two session connections are allowed in the network, determining whether the ongoing session connection is to be deleted comprises:
determining the ongoing session connection is to be deleted according to a command configured by the WLAN user.

15. The method of claim 1, wherein determining whether the ongoing session connection is to be deleted comprises:
if at least two session connections are allowed to be established for the WLAN user, determining whether one of the session connections is active; if one or more of these session connections are not active, allowing the access of the new session connection; if all the session connections are active, rejecting the new session connection corresponding to the authentication.

16. The method of claim 15, wherein determining whether one of the ongoing session connections is active further comprises one of:
initiating a re-authentication process to the ongoing session connection; and
sending a test signaling which requires a response from a WLAN UE utilized by the WLAN user.

17. The method of claim 1, wherein determining whether the ongoing session connection is to be deleted comprises:
if at least two session connections are allowed to be established for the WLAN user, authenticating a new session connection request corresponding to the authentication, and deleting the ongoing session connection with the lowest priority after the authentication for the new session setup request succeeds.

18. The method of claim 1, wherein determining whether the ongoing session connection is to be deleted comprises:
if at least two session connections are allowed to be established for the WLAN user, determining whether one of the session connections is active; if one or more of them are not active, allowing the access of the new session connection; if all the session connections are active, determining which session connection is to be deleted according to property information in session identifier information of the WLAN user.

19. The method of claim 18, wherein the property information in the session identifier information of the WLAN user comprises an access priority of the session connection.

20. The method of claim 1, wherein determining whether the ongoing session connection is to be deleted comprises:
determining the ongoing session connection to be deleted according to a limit-based deleting policy customized according to subscription of the WLAN user.

21. The method of claim 1, wherein determining whether the ongoing session connection is to be deleted comprises one of:
deleting the ongoing session connection after the authentication succeeds upon deciding to delete the current ongoing session connection;
rejecting the new session connection before the authentication is finished upon deciding to reject the new session connection; and
rejecting the new session connection in the course of the authentication of the new session setup request.

22. An Authentication, Authorization and Accounting (AAA) Server, adopted for determining whether an authentication corresponds to a new session connection for a Wireless Local Area Network (WLAN) user; and
determining whether an ongoing session connection is to be deleted according to at least one of a network configuration rule, user subscription information and whether a limit of the number of session connections for the WLAN user is exceeded, upon determining that the authentication corresponds to the new session connection.
